(19) United States
(12) Patent Application Publication
(10) Pub. No.: US 2020/0297162 A1
(43) Pub. Date: Sep. 24, 2020

(54) APPARATUS FOR COOKING FOOD

(71) Applicant: BONIOTTI S.R.L., Ome (Brescia) (IT)

(72) Inventor: Fulvio BONIOTTI, Rodengo Saiano (Brescia) (IT)

(21) Appl. No.: 16/360,533

(22) Filed: Mar. 21, 2019

(51) Int. Cl. A47J 37/07

(52) U.S. Cl. CPC A47J 37/0763; A47J 2037/0795; A47J 37/0786

(57) ABSTRACT

An Apparatus for cooking food including: a plate configured to be subjected to heating by a heat source, wherein the plate includes an upper surface for transmitting heat to a food to be cooked; a lid which can be reversibly coupled to the plate, wherein the lid, together with the upper surface, defines a cooking compartment; and a grill having a first and a second surfaces for supporting the food to be cooked opposite to each other, said grill being capable of being coupled inside the compartment between a first cooking configuration wherein the second supporting surface is spaced from the upper surface and a second cooking configuration wherein the first supporting surface is secured to the upper surface.

The present invention relates to an apparatus for cooking food.

In particular, the present invention relates to an apparatus for the multiple cooking of food, i.e., for cooking food using differentiated cooking techniques.

As is known, the different types of cooking are carried out using special pans, plates or other apparatuses specifically made based on the final cooking result to achieve and/or based on the type of food.

For example, in grilling, metal grills are used to support food, typically meat, fish or vegetables, which are disposed on gas, electric or charcoal heat sources. The grills have supporting frames to allow them to be arranged above the heat source at different heights based on the type of cooking and the intensity of the heat.

This type of cooking can also be carried out using corrugated plates, also known as “griddles”, made of cast iron or other types of alloy designed to efficiently retain heat.

On the other hand, in barbecuing, apparatuses consisting of grills or corrugated plates for supporting food, closed at the top by lids designed to retain the cooking fumes that characterize this type of cooking, are provided.

Furthermore, in typical broiling, pans and pots, which can have a smooth surface suitable, for example, for frying or for cooking egg-based food, are used.

Furthermore, in baking, suitable baking pans made of metal sheets defining a smooth surface for supporting food, such as, e.g., pizza or other baked food, are used.

Finally, in steaming, special closed pots having an inner perforated basket for containing food are provided. Below the basket, the water, which provides for cooking food by being brought to evaporation, is retained.

It is therefore apparent that, for each type of cooking, respective apparatuses are provided with the consequent drawbacks in terms of convenience of use and overall size.

In order to provide for the different types of cooking, actually, it is necessary to have plenty of space for containing each apparatus dedicated to a specific cooking. In this context, especially in a domestic setting, it is difficult to contain all the cooking apparatuses described above.

Moreover, it should be noted that some apparatuses as such prove to be structurally complicated and difficult to use, such as, e.g., the apparatuses for barbecuing or steaming which need a lid for retaining cooking fumes.

Apparatuses allowing the combination of two different types of cooking, such as, e.g., pots designed for broiling and provided with an airtight lid and a removable basket for a double typical broiling, sautéing and steaming, are also known. Cast iron plates with a lid which can be coupled to the plate itself for a combination of grilling and barbecuing are also known.

However, even these apparatuses have important drawbacks and limitations as for the type of cooking.

These apparatuses, indeed, prove to be in any case structurally complex, provided with a series of components (pot body basket, lid, etc.) which are not always easy to use, especially for users who are not particularly familiar with cooking activities.

In addition, these appliances are in any case able to apply only a very limited number of types of cooking, which, by the way, are not always practicable for each food.

The object of the present invention is therefore to provide an apparatus for cooking food which is able to overcome the above-mentioned drawbacks.

In greater detail, it is an object of the present invention to provide a single apparatus for cooking food, which can be used for different types of cooking, without having to provide a multitude of apparatuses, each for a specific type of cooking.

A further object of the present invention is to provide a structurally simple apparatus having a limited size and being easy to use.

Yet another object of the present invention is to provide an apparatus for cooking food which is versatile and usable for any food and for any type of cooking.

The mentioned technical task and the specified objects are substantially achieved by an apparatus for cooking food comprising the technical specifications set out in one or more of the appended claims.

Further characteristics and advantages of the present invention will become more apparent from the exemplary, and therefore non-limiting, description of a preferred, yet not exclusive, embodiment of an apparatus for cooking food of the type illustrated in the appended drawings, wherein:

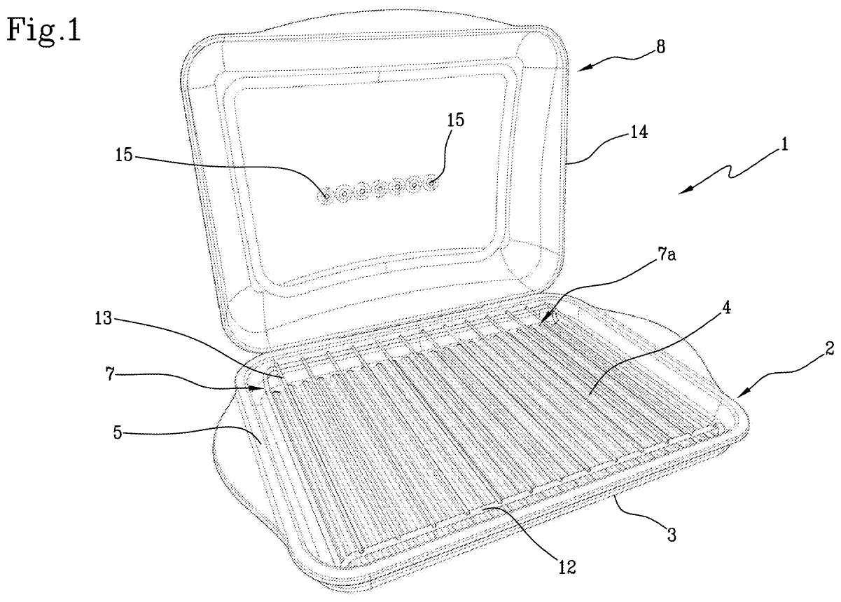

FIG. 1 shows a perspective view of an apparatus for cooking food according to the present invention;

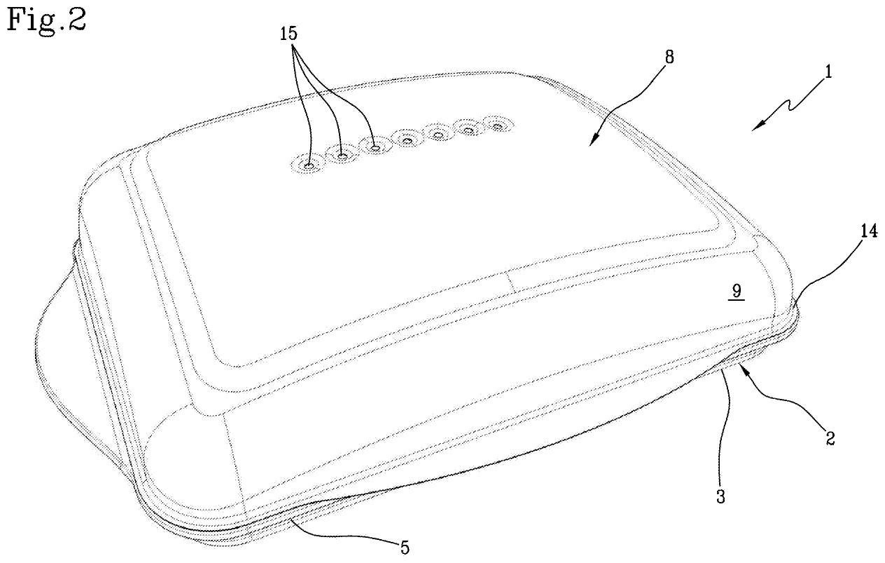

FIG. 2 shows a perspective view of the apparatus in FIG. 1 in a closed configuration thereof;

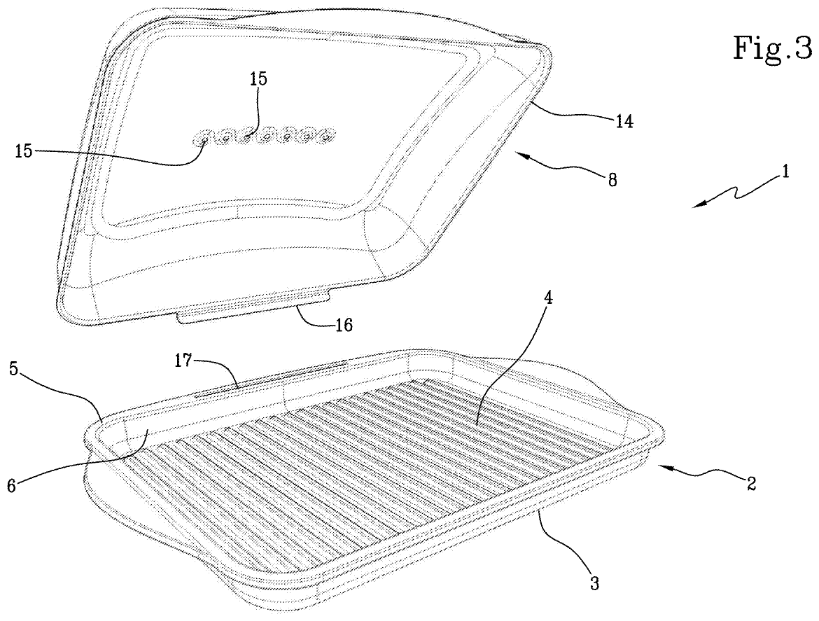

FIG. 3 shows a perspective view of the apparatus in FIG. 1 in an assembly condition thereof;

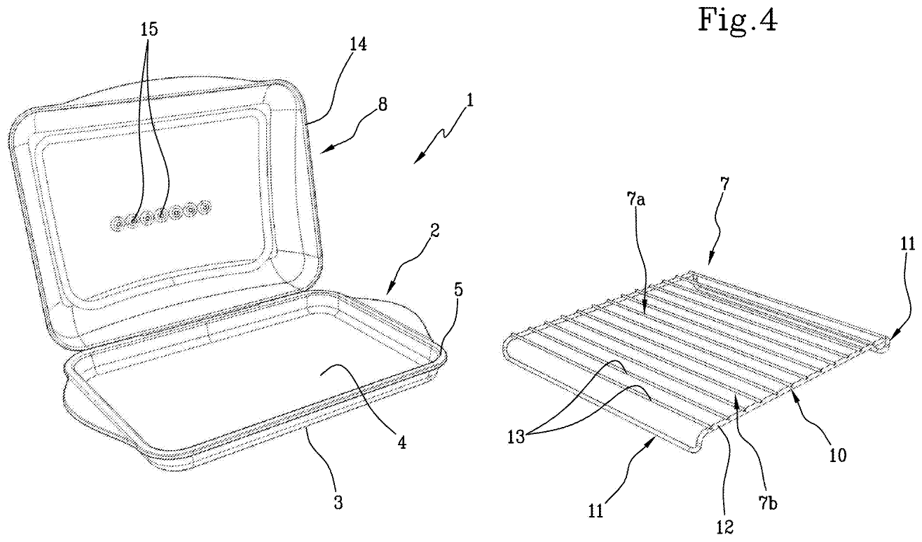

FIG. 4 shows a perspective view of a further embodiment of the apparatus according to the present invention and in a first cooking mode;

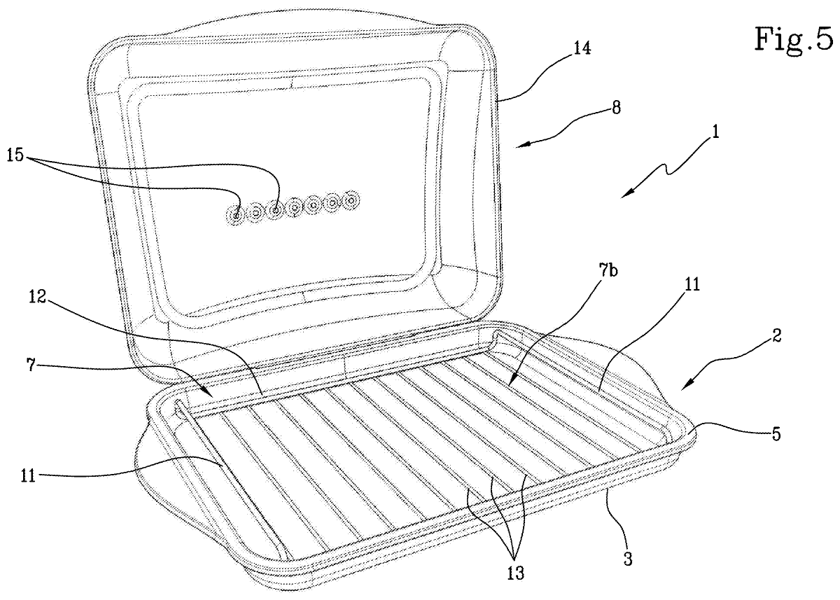

FIG. 5 shows a perspective view of the apparatus in FIG. 4 and in a second cooking mode; and

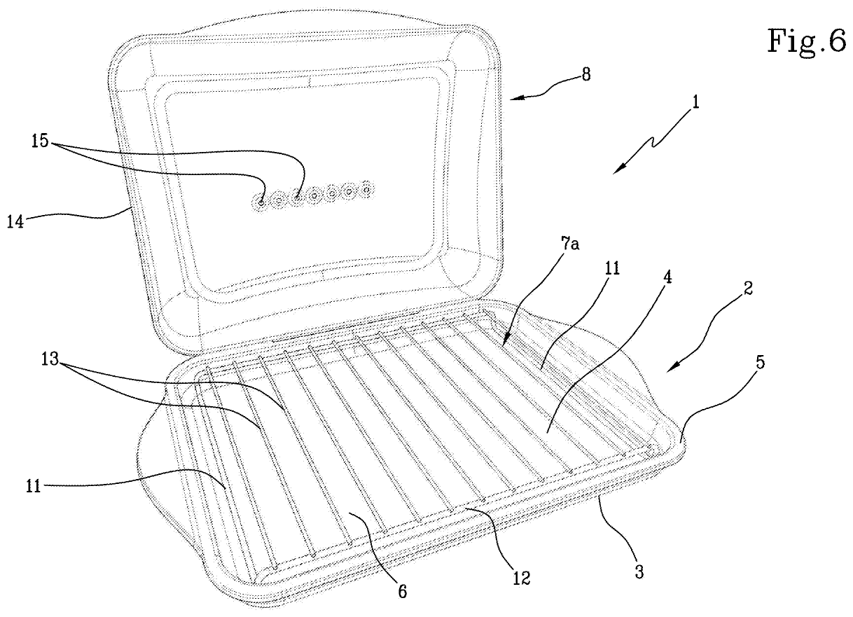

FIG. 6 shows a perspective view of the apparatus in FIG. 4 and in a third cooking mode.

With reference to the appended figures, reference number 1 indicates an apparatus for cooking food according to the present invention.

In particular, the apparatus 1 is designed to cook various types of food according to any type of cooking depending on the food itself and the various needs.

In greater detail, the apparatus 1 comprises a plate 2 configured to be subjected to heating by any heat source.

To this end, the plate 2 is made of a high thermal conductive material, such as, e.g., metal material or ferrous alloy, aluminium, optionally coated with non-stick material.

The plate 2 is made in the shape of a sheet defining a lower surface 3 arranged to be in contact with an open flame, and an upper surface 4 for transmitting heat to a food to be cooked (not shown in the appended figures).

Furthermore, according to the first embodiment of FIGS. 1 and 3, the upper surface 4 has a corrugated outline, i.e., provided with a series of projections alternating with a series of grooves. In this solution, the upper surface 4 can be used to directly support the food to be cooked, to be used for example as a griddle or to grill food.

In accordance with the second embodiment illustrated in FIGS. 4 to 6, the upper surface 4 has a smooth outline to directly support the food to be cooked. In this case, the plate 2 is used as an actual pan, for cooking, e.g., eggs, for frying food or for sautéing. Furthermore, the plate can be placed in the oven, for cooking pizza, cakes and other baked food.

The plate 2 advantageously has a substantially rectangular edging 5 protruding perpendicularly from the upper surface 4.

This way, the edging 5, together with the upper surface, defines an area 6 for containing an evaporation liquid, as will be better explained later in the present discussion.

The apparatus 1 also comprises a lid 8 which can be reversibly coupled to the plate 2, so that it can be coupled to and uncoupled from the plate 2 itself.

The lid 8, coupled to the plate 2 and closed on the plate 2 itself (FIG. 2) defines, together with the upper surface 4, a cooking compartment 9.

Inside the cooking compartment 9, a grill 7 having a first surface 7a and a second surface 7b opposite to each other and both used to support the food to be cooked can also be arranged. The grill 7 can be arranged inside the compartment 9 between a first cooking configuration (FIGS. 1 and 6) wherein the second supporting surface 7b is spaced from the upper surface 4, and in a second cooking configuration (FIG. 5) wherein the first supporting surface 7a is secured to the upper surface 4.

That is, it should be noted that the grill 7 can be arranged inside the compartment 9, and more precisely inside the edging 5 of the plate 2, in two different positions and with the first surface 7a facing upwards to support the food, or upside down with the second surface 7b upwards to support the food, respectively.

In the first cooking configuration (FIGS. 1 and 6) wherein the foods are resting on the first surface 7a, and the second surface 7b is spaced from the upper surface 4 of the plate 2, the area 6 can be filled with a liquid, typically water, for steaming.

Therefore, in the first cooking configuration, the apparatus 1 is used for grilling and/or for steaming.

In the second cooking configuration (FIG. 5), a smooth upper surface 4 is mainly used to be able to grill in any case.

Advantageously, the grill 7 consists of a grate. Said grill 7 has a substantially C-shaped cross-sectional conformation having a flat portion 10 defining the surfaces 7a, 7b for supporting food, and two lateral portions 11 parallel to each other and arranged on opposite sides of the flat portion 10.

The side portions 11 thus protrude from the second surface 7b for supporting food.

In greater detail, the grill comprises a substantially rectangular frame 12 and a plurality of parallel rods 13 spaced apart from one another, extending between two opposite sides of the frame 12 to define the above-mentioned surfaces 7a, 7b.

In this situation, the side portions 11 are defined by two smaller sides of the frame 12 folded perpendicularly with respect to the planar development of the supporting surfaces 7a, 7b.

As a result, in the first cooking configuration (FIGS. 1 and 5), the side portions 11 are thus attached to the upper surface 4 of the plate 2 in order to space the supporting surfaces 7a, 7b from the plate 2 itself.

The lid 8 has a substantially rounded conformation with its convex part facing the upper surface 4.

The lid 8 has a peripheral edging 14 which coincides and can be coupled to the edging 5 of the plate 2 (FIG. 2) to define the closed compartment 9 and to contain the fumes for barbecuing or for steaming.

Moreover, the lid is provided with at least one opening 15 for expelling excess steam and/or cooking fumes and generated inside the compartment 9.

Preferably, a series of openings 15 aligned with each other and arranged centrally on the top of the lid 8 is provided.

Each opening 15 preferably has, cross-sectionally, an increasing passage section from the space 9 towards an area outside the lid 8.

That is, the hole 15 is thus divergent in the direction of expulsion of the cooking gases.

Advantageously, this configuration makes it possible to expel the gases more quickly outside the compartment 9 and to better distribute the hot gases outside the lid 8.

As mentioned above, the lid 8 can be reversibly coupled to the plate 2.

A flap 16 projecting from the peripheral edging 14 and insertable into a through opening 17 formed in the edging 5 of the plate 2 (as is better illustrated in FIG. 3) is actually provided.

This way, the lid 8 can be fastened to the plate 2 and possibly re-closed on the plate itself in order to retain the cooking fumes. Also note that, during cooking, it is possible to keep the lid open (FIG. 1). In this case, it is not necessary to have other shelves to support the lid when it is not used, unlike the known lids which, if removed, must necessarily be stored.

The present invention overcomes the drawbacks of the prior art and provides significant advantages.

First of all, it should be noted that the apparatus 1 can be used for a multitude of types of cooking. The plate 2 alone, indeed, can be used as a baking pan for oven baking or for broiling, as a frying pan for frying, or as a griddle for grilling.

In addition, using the grill 7, the apparatus 1 can be used for grilling with food in direct contact with the plate 2 (FIG. 5) for a more immediate cooking, or with food separated from the plate 2 (FIGS. 1 and 6) for a slower cooking.

Furthermore, the presence of the lid 8 allows to retain the fumes and vapours inside the compartment 9 for steaming (adding water in the area 6) or for barbecuing.

Therefore, the appliance 1 alone solves the drawbacks of overall size due to the presence of different and special apparatuses for specific types of cooking.

Furthermore, the presence of the lid allows to considerably increase the temperature inside the compartment, optimizing the time and the power required for cooking.

All these types of cooking are implemented by the apparatus 1 which turns out to be structurally very simple and therefore particularly low cost.

Moreover, the apparatus 1 turns out to be easy to use since it has a very limited number of parts which can be separated from each other and can be used immediately without particular technical skills.

Furthermore, the apparatus 1 turns out to be portable and compact, as well as completely dishwasher safe for an increased convenience of use.

1. An apparatus for cooking food comprising;
a plate configured to be subjected to heating by a heat source, wherein the plate comprises an upper surface for transmitting heat to a food to be cooked;
a lid which can be reversibly coupled to the plate, wherein the lid, together with the upper surface, defines a cooking compartment; and
a grill having a first and a second surfaces for supporting the food to be cooked opposite to each other, said grill being capable of being coupled inside the compartment between a first cooking configuration wherein the second supporting surface is spaced from the upper surface and a second cooking configuration wherein the first supporting surface is secured to the upper surface.

2. The apparatus according to claim 1, wherein the grill has a substantially C-shaped cross-sectional conformation and having a flat portion defining said surfaces for supporting food and two side portions parallel to each other and arranged on opposite sides of the flat portion; said side portions protruding from the second supporting surface.

3. The apparatus according to claim 2, wherein said grill comprises a substantially rectangular frame and a plurality of parallel rods spaced apart from one another, extending between two opposite sides of said frame; said side portions being defined by two smaller sides of the frame folded perpendicularly with respect to the planar development of said supporting surfaces.

4. The apparatus according to claim 1, wherein in said plate has a substantially rectangular edging protruding perpendicularly from said upper surface; said grill in the first and in the second cooking configurations being contained within the edging.

5. The apparatus according to claim 4, wherein said edging, in the first cooking configuration of the grate, defines an area for containing an evaporation liquid.

6. The apparatus according to claim 1, wherein said upper surface for transmitting heat is corrugated.

7. The apparatus according to claim 1, wherein said upper surface for transmitting heat is smooth.

8. The apparatus according to claim 4, wherein said lid has a substantially rounded conformation with its convex part facing the upper surface;
said lid having a peripheral edging which coincides and can be coupled to the edging of the plate.

9. The apparatus according to claim 8, wherein the lid has at least one opening for expelling steam and/or cooking fumes generated in said compartment.

10. The apparatus according to claim 9, wherein said opening has, cross-sectionally, an increasing passage section from said compartment towards an area outside the lid.

11. The apparatus according to claim 8, wherein said lid further comprises a flap projecting from said peripheral edging and insertable into a through opening formed in said edging.
